(19) United States
(12) Patent Application Publication
(10) Pub. No.: US 2019/0294542 A1
(43) Pub. Date: Sep. 26, 2019

(54) MEMORY SYSTEM AND OPERATING METHOD THEREOF

(71) Applicant: SK hynix Inc., Gyeonggi-do (KR)

(72) Inventor: Joo Young LEE, Seoul (KR)

(21) Appl. No.: 16/153,027

(22) Filed: Oct. 5, 2018

(30) Foreign Application Priority Data
Mar. 26, 2018 (KR) 10-2018-0034671

(51) Int. Cl. G06F 12/0804

(52) U.S. Cl. CPC G06F 12/0804; G06F 2212/7203; G06F 2212/1032

(57) ABSTRACT

There are provided a memory system and an operating method thereof. The memory system includes: a memory controller for queuing commands received from a host, and sequentially outputting the queued commands; a controller buffer memory for temporarily storing write data corresponding to the commands, and outputting the temporarily stored write data under the control of the memory controller; and a nonvolatile memory device for performing operations in response to the commands output from the memory controller and the write data output from the controller buffer memory, and outputting an operation completion signal to the memory controller when the operations are complete, wherein, when a flush command is received from the host, the memory controller releases the write data temporarily stored in the controller buffer memory.

### CROSS-REFERENCE TO RELATED APPLICATION

The present application claims priority under 35 U.S.C. § 119(a) to Korean patent application number 10-2018-0034671, filed on Mar. 26, 2018, the entire disclosure of which is herein incorporated herein by reference in its entirety.

### BACKGROUND

### 1. Field of Invention

Various exemplary embodiments of the present invention generally relate to a memory system and an operating method thereof. Particularly, the embodiments relate to a memory system capable of improving the performance of a write operation and an operating method of the memory system.

### 2. Description of Related Art

The computer environment paradigm has been shifting towards ubiquitous computing, which enables computer systems to be used anywhere and anytime. As a result, use of portable electronic devices such as mobile phones, digital cameras, laptop computers, and the like has rapidly increased. Such portable electronic devices may generally include a memory system using a memory device, i.e., a data storage device. The data storage device is used as a main memory device or an auxiliary memory device of the portable electronic devices.

A data storage device using a memory device has excellent stability and durability, high information access speed, and low power consumption, since there is no mechanical driving part. In an example of memory systems having such advantages, the data storage device includes a Universal Serial Bus (USB) memory device, memory cards having various interfaces, a Solid State Drive (SSD), and the like.

### SUMMARY

Embodiments provide a memory system capable of storing data of commands in a controller buffer memory during a flush operation thereof, and an operating method of the memory system.

According to an aspect of the present disclosure, there is provided a memory system including: a memory controller configured to queue commands received from a host, and sequentially output the queued commands; a controller buffer memory configured to temporarily store write data corresponding to the commands, and output the temporarily stored write data under the control of the memory controller; and a nonvolatile memory device configured to perform operations in response to the commands output from the memory controller and the write data output from the controller buffer memory, and output an operation completion signal to the memory controller when the operations are complete, wherein, when a flush command is received from the host, the memory controller releases the write data temporarily stored in the controller buffer memory.

According to another aspect of the present disclosure, there is provided a memory system including: a memory controller configured to receive commands and write data corresponding to the commands from a host, queue the received commands, and output the queued commands and the write data; and a nonvolatile memory device configured to perform operations in response to the commands and the write data, which are output from the memory controller, and outputs an operation completion signal to the memory controller when the operations are complete, wherein, when a flush command is received, the memory controller releases the write data temporarily stored after the write data are transmitted to the nonvolatile memory device.

According to still another aspect of the present disclosure, there is provided a method for operating a memory system, the method including: queuing commands received from a host, and temporarily storing write data corresponding to the commands in a controller buffer memory; performing operations by transmitting the queued commands and the write data stored in the controller buffer memory to a nonvolatile memory device; when a flush command is received from the host, queuing the flush command next to the queued commands, and releasing the write data temporarily stored in the controller buffer memory; and queuing, next to the flush command, new commands received from the host after the flush command is received, and temporarily storing new write data corresponding to the new commands in the controller buffer memory from which the write data are released.

According to an aspect of the present disclosure, there is provided a memory system including: a memory device including a memory cell array; a buffer; and a controller configured to: queue commands on a first-in-first-out (FIFO) basis; buffer in the buffer data corresponding to the queued commands; and control the memory device to perform operations on the memory cell array by providing the memory device with the queued commands and the buffered data, wherein, at a time point when a flush command is queued, the controller is further configured to: clear the buffer by preferentially providing the memory device with the buffered data; and control the memory device to perform the operations with the preferentially provided data by providing the memory device with the commands queued prior to the flush command.

### BRIEF DESCRIPTION OF THE DRAWINGS

Example embodiments will now be described in more detail hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawings, dimensions of the figures may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a memory system according to an embodiment of the present disclosure.

FIG. 2 is a diagram illustrating a memory controller of FIG. 1.

FIG. 3 is a diagram illustrating a memory system according to another embodiment of the present disclosure.

FIG. 4 is a diagram illustrating a nonvolatile memory device of FIG. 1.

FIG. 5 is a diagram illustrating a memory block of FIG. 4.

FIG. 6 is a flowchart describing an operating method of the memory system according to an embodiment of the present disclosure.

FIGS. 7A to 7D are diagrams of a command queue and a memory buffer or buffer memory device for illustrating the operating method of the memory system according to the embodiment of the present disclosure.

FIG. 8 is a diagram illustrating an embodiment of the memory system.

FIG. 9 is a diagram illustrating an embodiment of the memory system.

FIG. 10 is a diagram illustrating an embodiment of the memory system.

FIG. 11 is a diagram illustrating an embodiment of the memory system.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

The embodiments according to the concept of the present disclosure can be variously modified and have various shapes. Thus, the embodiments are illustrated in the drawings and are intended to be described herein in detail. However, the embodiments according to the concept of the present disclosure are not construed as limited to specified disclosures, and include all changes, equivalents, or substitutes that do not depart from the spirit and technical scope of the present disclosure.

While terms such as “first” and “second” may be used to describe various components, such components must not be understood as being limited to the above terms. The above terms are used only to distinguish one component from another. For example, a first component may be referred to as a second component without departing from the scope of rights of the present disclosure, and likewise a second component may be referred to as a first component.

It will be understood that when an element is referred to as being “connected” or “coupled” to another element, it can be directly connected or coupled to the other element or intervening elements may also be present. In contrast, when an element is referred to as being “directly connected” or “directly coupled” to another element, no intervening elements are present. Meanwhile, other expressions describing relationships between components such as “between,” “immediately between” or “adjacent to” and “directly adjacent to” may be construed similarly.

The terms used in the present application are merely used to describe particular embodiments, and are not intended to limit the present disclosure. Singular forms in the present disclosure are intended to include the plural forms and vice versa, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless expressly stated otherwise, all terms used herein including technical or scientific terminologies have meanings that they are commonly understood by those skilled in the art to which the present disclosure pertains. The terms having the definitions as defined in the dictionary should be understood such that they have meanings consistent with the context of the related technique. Unless expressly stated otherwise in this application, terms should not be understood in an ideally or excessively formal way.

In describing those embodiments, various descriptions will be omitted for techniques that are well known to the art to which the present disclosure pertains, and are not directly related to the present disclosure. This disclosure intends to disclose only the gist of the present disclosure more clearly by omitting unnecessary description.

It is noted that reference to “an embodiment” does not necessarily mean only one embodiment, and different references to “an embodiment” are not necessarily to the same embodiment(s).

Hereinafter, exemplary embodiments of the present disclosure will be described in detail with reference to the accompanying drawings in order for those skilled in the art to be able to readily implement the technical spirit of the present disclosure.

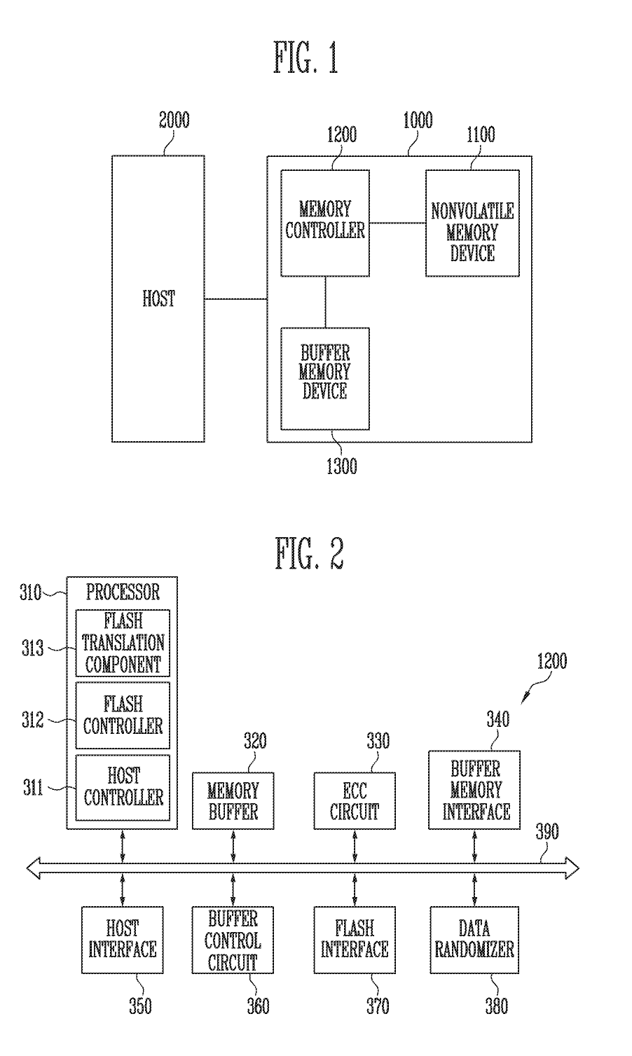

FIG. 1 is a diagram illustrating a memory system 1000 according to an embodiment of the present disclosure.

Referring to FIG. 1, the memory system 1000 may include a nonvolatile memory device 1100 that retains stored data even when power is cut off, a buffer memory device 1300 for temporarily storing data, and a memory controller 1200 for controlling the nonvolatile memory device 1100 and the buffer memory device 1300 under the control of a host 2000.

The host 2000 may communicate with the memory system 1000, using at least one of various communication manners, such as a Universal Serial Bus (USB), a Serial AT Attachment (SATA), a High Speed InterChip (HSIC), a Small Computer System Interface (SCSI), Firewire, a Peripheral Component Interconnection (PCI), a PCI Express (PCI-e or PCIe), a NonVolatile Memory Express (NVMe), a Universal Flash Storage (UFS), a Secure Digital (SD), a MultiMedia card (MMC), an Embedded MMC (eMMC), a Dual In-line Memory Module (DIMM), a Registered DIMM (RDIMM), a Load Reduced DIMM (LRDIMM), and the like.

The memory controller 1200 may control the overall operations of the memory system 1000, and control data exchange between the host 2000 and the nonvolatile memory device 1100. For example, the memory controller 1200 may control the nonvolatile memory device 1100 to perform read, write, erase, and background operations in response to a command received from the host 2000. Also, when a flush command is received from the host 2000, the memory controller 1200 may check whether an operation has completely performed in the nonvolatile memory device 1100 in response to a command received before the flush command is received, and output a response signal corresponding to the flush command to the host 2000. In some embodiments, the nonvolatile memory device 1100 may include a flash memory.

The memory controller 1200 may control data exchange between the host 2000 and the buffer memory device 1300 or temporarily store system data for controlling the nonvolatile memory device 1100 in the buffer memory device 1300. The buffer memory device 1300 may be used as a working memory, a cache memory or a buffer memory of the memory controller 1200. The buffer memory device 1300 may store codes and commands, which are performed by the memory controller 1200. Also, the buffer memory device 1300 may store data processed by the memory controller 1200.

The memory controller 1200 may temporarily store data input from the host 200 in the buffer memory device 1300 and then transmit the data temporarily stored in the buffer memory device 1300 to the nonvolatile memory device 1100 to be stored in the nonvolatile memory device 1100. Also, the memory controller 1200 may receive data and a logical address, which are input from the host 2000, and translate the logical address to a physical address indicating an area in which data is to be actually stored in the nonvolatile memory device 1100. Also, the memory controller 1200 may store, in the buffer memory 1300, a logical-to-physical address mapping table that establishes a mapping relationship between the logical address and the physical address.

In some embodiments, the buffer memory device 1300 may include a Double Data Rate Synchronous Dynamic Random Access Memory (DDR SDRAM), a Low Power Double Data Rate 4 (LPDDR4) SDRAM, a Graphics Double Data Rate (GDDR) SDRAM, a Low Power DDR (LPDDR), a Rambus Dynamic Random Access Memory (RDRAM), etc.

In some embodiments, the memory system 1000 may not include the buffer memory device 1300.

The memory controller 1200 according to the embodiment of the present disclosure queues commands received from the host 2000, based on their orders of priority, and temporarily stores data (e.g., write data) received together with the commands from the host 2000 in the buffer memory device 1300 or a memory buffer in the memory controller 1200. After this, a queued command and data corresponding to the queued command are transmitted to the nonvolatile memory device 1100. When the nonvolatile memory device 1100 completes an operation corresponding to the received command, the data temporarily stored in the buffer memory device 1300 or the memory buffer may be released. When a flush command is received from the host 2000, the memory controller 1200 performs a flush operation. The flush operation ensures completion of operations in response to commands received earlier than the flush command. The memory controller 1200 preferentially processes operations in response to commands received earlier than the flush command. When the operations are successfully completed in response to the commands received earlier than the flush command, the memory controller 1200 may output a response signal corresponding to the flush command. In the flush operation, the memory controller 1200 may control the data temporarily stored in the buffer memory device 1300 or the memory buffer to be output to the nonvolatile memory device 1100, and then control the data temporarily stored in the buffer memory device 1300 or the memory buffer to be released before the nonvolatile memory device 1100 completes the operation in response to the received command. The memory controller 1200 may store, in the buffer memory device 1300 or the memory buffer, new data corresponding to new commands input after the flush command is received.

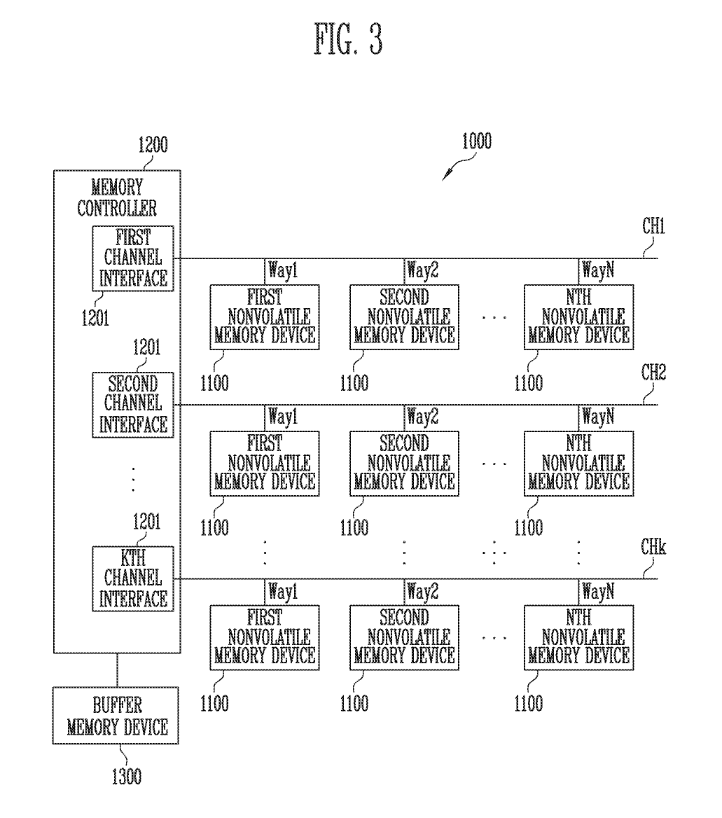

FIG. 2 is a diagram illustrating the memory controller 1200 of FIG. 1.

Referring to FIG. 2, the memory controller 1200 may include a processor 310, a memory buffer 320, an error correction code (ECC) circuit 330, a buffer memory interface 340, a host interface 350, a buffer control circuit 360, a flash interface 370, a data randomizer 380, and a bus 390.

The bus 390 may be configured to provide channels between components of the memory controller 1200.

The processor 310 may control the overall operations of the memory controller 1200, and perform a logical operation. The processor 310 may communicate with the external host 2000 of FIG. 1 through the host interface 350, and communicate with the nonvolatile memory device 1100 of FIG. 1 through the flash interface 370. Also, the processor 310 may communicate with the buffer memory device 1300 of FIG. 1 through the buffer memory interface 340. Also, the processor 310 may control the memory buffer 320 through the buffer control circuit 360. The processor 310 may control an operation of the memory system 1000 by using the memory buffer 320 as a working memory, a cache memory or a buffer memory.

The processor 310 may generate a command queue by queuing a plurality of commands input from the host 2000, based on their orders of priority. Such an operation is referred to as a multi-queue. The processor 310 may sequentially transmit the plurality of queued commands to the nonvolatile memory device 1100 and control the nonvolatile memory device 1100 to perform overall operations (e.g., a read, write or erase) in response to the received commands. Also, when a flush command is received from the host 2000, the processor 310 may generate and output a response signal corresponding to the flush command when commands received before the flush command is received are all transmitted to the nonvolatile memory device 1100 such that operations have been completely performed in response to the commands. The processor 310 may determine whether the general operation has been completed in response to the command according to an operation completion signal received from the nonvolatile memory device 1100.

The memory buffer 320 may be used as the working memory, the cache memory or the buffer memory of the processor 310. The memory buffer 320 may store codes and commands, which are executed by the processor 310. The memory buffer 320 may store data processed by the processor 310. The memory buffer 320 may include a Static RAM (SRAM) or a Dynamic RAM (DRAM). The memory buffer 320 may store a command queue configured with a plurality of commands queued by the processor 310, and be used as a write buffer to store data received from the host 2000.

The ECC circuit 330 may perform error correction. The ECC circuit 330 may perform ECC encoding on data to be written in the nonvolatile memory device 1100 through the flash interface 370. The ECC-encoded data may be transferred to the nonvolatile memory device 1100 through the flash interface 370. The ECC circuit 330 may perform ECC decoding on data received from the nonvolatile memory device 1100 through the flash interface 370. In an example, the ECC circuit 330 may be included as a component of the flash interface 370 in the flash interface 370.

The buffer memory interface 340 may be configured to communicate with the buffer memory device 1300 under the control of the processor 310. The buffer memory interface 340 may communicate a command, an address, and data with the buffer memory device 1300 through a channel.

The host interface 350 is configured to communicate with the external host 2000 under the control of the processor 310. The host interface 350 may be configured to communicate with the host 2000, using at least one of various communication manners, such as a Universal Serial Bus (USB), a Serial AT Attachment (SATA), a High Speed InterChip (HSIC), a Small Computer System Interface (SCSI), Firewire, a Peripheral Component Interconnection (PCI), a PCI express (PCIe), a Nonvolatile Memory Express (NVMe), a Universal Flash Storage (UFS), a Secure Digital (SD), a MultiMedia Card (MMC), an Embedded MMC (eMMC), a Dual In-line Memory Module (DIMM), a Registered DIMM (RDIMM), and a Load Reduced DIMM (LRDIMM).

The buffer control circuit 360 is configured to control the memory buffer 320 under the control of the processor 310.

The flash interface 370 is configured to communicate with the nonvolatile memory device 1100 under the control of the processor 310. The flash interface 370 may communicate a command, an address, and data with the nonvolatile memory device 1100 through a channel.

Although FIG. 2 shows as an example that the memory controller 1200 includes the memory buffer 320 and the buffer control circuit 360, the present invention is not limited thereto. That is, the memory buffer 320 and the buffer control circuit 360 may be provided separately and the memory controller 1200 may not include the memory buffer 320 and the buffer control circuit 360.

In an example, the processor 310 may control an operation of the memory controller 1200 by using codes. The processor 310 may load codes from a nonvolatile memory device (e.g., a read only memory (ROM)) provided in the memory controller 1200. In another example, the processor 310 may load codes from the nonvolatile memory device 1100 through the flash interface 370.

The data randomizer 380 may randomize data or de-randomize the randomized data. The data randomizer 380 may perform a data randomizing operation on data to be written in the nonvolatile memory device 1100 through the flash interface 370. The randomized data may be transmitted to the nonvolatile memory device 1100 through the flash interface 370. The data randomizer 380 may perform a data de-randomizing operation on data received from the nonvolatile memory device 1100 through the flash interface 370. In an example, the data randomizer 380 may be included as a component of the flash interface 760 in the flash interface 370.

In an example, the bus 390 of the memory controller 1200 may be divided into a control bus and a data bus. The data bus may be configured to transmit data in the memory controller 1200, and the control bus may be configured to transmit control information such as a command and an address in the memory controller 1200. The data bus and the control bus are separated from each other, and may not interfere or influence with each other. The data bus may be coupled to the host interface 350, the buffer control circuit 360, the ECC circuit 330, the flash interface 370, and the buffer memory interface 340. The control bus may be coupled to the host interface 350, the processor 310, the buffer control circuit 360, the flash interface 370, and the buffer memory interface 340. In some embodiments, the memory controller 1200 may not include the buffer memory interface 340.

The memory system 1000 may receive a write command, write data, and a logical address from the host 2000. The memory controller 1200 may allocate a physical storage space, i.e., a memory block or page of the nonvolatile memory device 1100, in which the write data is to be stored, in response to the write command. In other words, the memory controller 1200 may map a physical address corresponding to the logical address in response to the write command. The physical address may be referred to as a flash logical address to be distinguished from a host physical address. The physical address may be an address corresponding to the physical storage space of the nonvolatile memory device 1100, in which the write data input from the host 2000 is to be stored.

The memory system 1000 may store, in a memory block of the nonvolatile memory device 1100, mapping information between the logical address and the physical address, i.e., physical-to-logical address mapping information. The memory block that stores the physical-to-logical address mapping information may be referred to as a system block.

When the memory system 1000 is booted, logical-to-physical address mapping information stored in the nonvolatile memory device 110 may be loaded to the buffer memory device 1300 or the memory buffer 320. Also, when it is required to check logical-to-physical address mapping information stored in the nonvolatile memory device 110, the memory system 1000 may read the logical-to-physical address mapping information from the nonvolatile memory device 1100 and store the read logical-to-physical address mapping information in the buffer memory device 1300 or the memory buffer 320. The buffer memory device 1300 or the memory buffer 320 may be commonly referred to as a controller buffer memory.

In another example, when the memory system 1000 receives a write command, write data, and a logical address from the host 2000, the memory controller 1200 may allocate a physical storage space of the nonvolatile memory device 1100, in which the write data is to be stored, in response to the write command. That is, the memory controller 1200 may map a physical address corresponding to the logical address in response to the write command. Mapping information between a newly generated logical address and the physical address, i.e., physical-to-logical address mapping information may be updated in the buffer memory device 1300 or the memory buffer 320. As described above, the physical address indicating a data storage space in the nonvolatile memory device 1100 may be referred to as a flash physical address.

The memory system 1000 may receive a read command and a logical address from the host 2000. The memory system 1000 may check a physical address corresponding to the logical address from the logical-to-physical address mapping information stored in the nonvolatile memory device 1100 in response to the read command, read data stored in a memory area corresponding to the physical address, and output the read data to the host 2000.

The processor 310 may include a host controller 311, a flash controller 312, and a flash translation component 313.

The host controller 311 may control data transmission between the host 2000, and the host interface 350 and the controller buffer memory, i.e., the memory buffer 320 or the buffer memory device 1300. In an example, the host controller 311 may control an operation of buffering write data input from the host 2000 to the memory buffer 320 or the buffer memory device 1300 through the host interface 350. In another example, the host controller 311 may control an operation of outputting read data buffered to the memory buffer 320 or the buffer memory device 1300 to the host 2000 through the host interface 350.

The flash controller 312 may transmit a write command to the nonvolatile memory device 1100 in a write operation, and control a write operation by transmitting write data buffered to the memory buffer 320 or the buffer memory device 1300 to the nonvolatile memory device 1100. In an example, the write data buffered to the memory buffer 320 or the buffer memory device 1300 are temporarily stored in the memory buffer 320 or the buffer memory device 1300 after the write data is transmitted to the nonvolatile memory device 1100. This is for re-performing the write operation in which the error occurs, using the write data buffered to the memory buffer 320 or the buffer memory device 1300 when an error occurs in a write operation of the nonvolatile memory device. When a flush command is received from the host 2000, the flash controller 312 may transmit data buffered to the memory buffer 320 or the buffer memory device 1300 to the nonvolatile memory device 1100, and release all write data temporarily stored in the memory buffer 320 or the buffer memory device 1300. Accordingly, a storage space of the memory buffer 320 or the buffer memory device 1300 can be secured, and write data newly received from the host 2000 after the flush command is received can be stored in the memory buffer 320 or the buffer memory device 1300.

In another example, the flash controller 312 may control an operation of buffering read data read and output from the nonvolatile memory device in a read operation to the memory buffer 320 or the buffer memory device 1300.

The flash translation component 313 may map a physical address corresponding to a logical address input from the host 2000 in a data write operation. Data may be written in a storage space of the nonvolatile memory device 1100, which corresponds to the mapped physical address. The flash translation component 313 may check the physical address mapped to the logical address input from the host 2000 in the data write operation, and transmit the physical address to the flash controller 312. The flash controller 312 may read data from the storage space of the nonvolatile memory device 1100, which corresponds to the physical address. The physical address indicating a storage space of the nonvolatile memory device 1100 may be referred to as a flash physical address to be distinguished from the host physical address.

FIG. 3 is a diagram illustrating a memory system 1000 according to another embodiment of the present disclosure. Specifically, FIG. 3 illustrates the memory system 1000 including a plurality of nonvolatile memory devices 1100 coupled to a memory controller 1200 through a plurality of channels CH1 to CHk.

Referring to FIG. 3, the memory controller 1200 may communicate with the plurality of nonvolatile memory devices 1100 through the plurality of channels CH1 to CHk. The memory controller 1200 may include a plurality of channel interfaces 1201, and each of the plurality of channels CH1 to CHk may be coupled to any one of the plurality of channel interfaces 1201. In an example, a first channel CH1 may be coupled to a first channel interface 1201, a second channel CH2 may be coupled to a second channel interface 1201, and a kth channel CHk may be coupled to a kth channel interface 1201. Each of the plurality of channels CH1 to CHk may be coupled to one or more nonvolatile memory devices 1100. In addition, nonvolatile memory devices 1100 coupled to different channels may operate independently from each other. In other words, the nonvolatile memory device 1100 coupled to the first channel CH1 and the nonvolatile memory device 1100 coupled to the second channel CH may operate independently from each other. In an example, the memory controller 1200 may communicate, in parallel, data or a command with the nonvolatile memory device 1100 coupled to the second channel CH2 through the second channel CH2 while communicating data or a command with the nonvolatile memory device 1100 coupled to the first channel CH1 through the first channel CH1.

Each of the plurality of channels CH1 to CHk may be coupled to a plurality of nonvolatile memory devices 1100. A plurality of nonvolatile memory devices 1100 coupled to one channel may constitute different ways Way. In an example, N nonvolatile memory devices 1100 may be coupled to one channel, and constitute different ways. That is, first to Nth nonvolatile memory devices 1100 may be coupled to the first channel CH1, the first nonvolatile memory device 1100 may constitute a first way Way1, the second nonvolatile memory device 1100 may constitute a second way Way2, and the Nth nonvolatile memory device 1100 may constitute an Nth way WayN. In addition, two or more nonvolatile memory devices 1100 may constitute one way Way.

Since the first to Nth nonvolatile memory devices 1100 coupled to the first channel CH1 share the first channel CH1, the first to Nth nonvolatile memory devices 1100 cannot simultaneously communicate data or a command with the memory controller 1200 but may sequentially communicate data or a command with the memory controller 1200. In other words, while the memory controller 1200 is transmitting data to the first nonvolatile memory device 1100 constituting the first way Way1 of the first channel CH1 through the first channel CH1, the second to Nth nonvolatile memory devices 1100 constituting the second to Nth ways Way2 to WayN of the first channel CH1 cannot communicate data or a command with the memory controller 1200 through the first channel CH1. In other words, while any one of the first to Nth nonvolatile memory devices 1100 that share the first channel CH1 is occupying the first channel CH1, the other nonvolatile memory devices 1100 coupled to the first channel CH1 cannot use the first channel CH1.

The first nonvolatile memory device 1100 constituting the first way Way1 of the first channel CH1 and a first nonvolatile memory device 1100 constituting a first way of a second channel CH2 may independently communicate with the memory controller 1200. In other words, when the memory controller 1200 communicates data with the first nonvolatile memory device 1100 constituting the first way Way1 of the first channel CH1 through the first channel CH1 and the first channel interface 1201, the memory controller 1200 at the same time may communicate data with the first nonvolatile memory device 1100 constituting the first way Way1 of the second channel CH2 through the second channel and the second channel interface 1201.

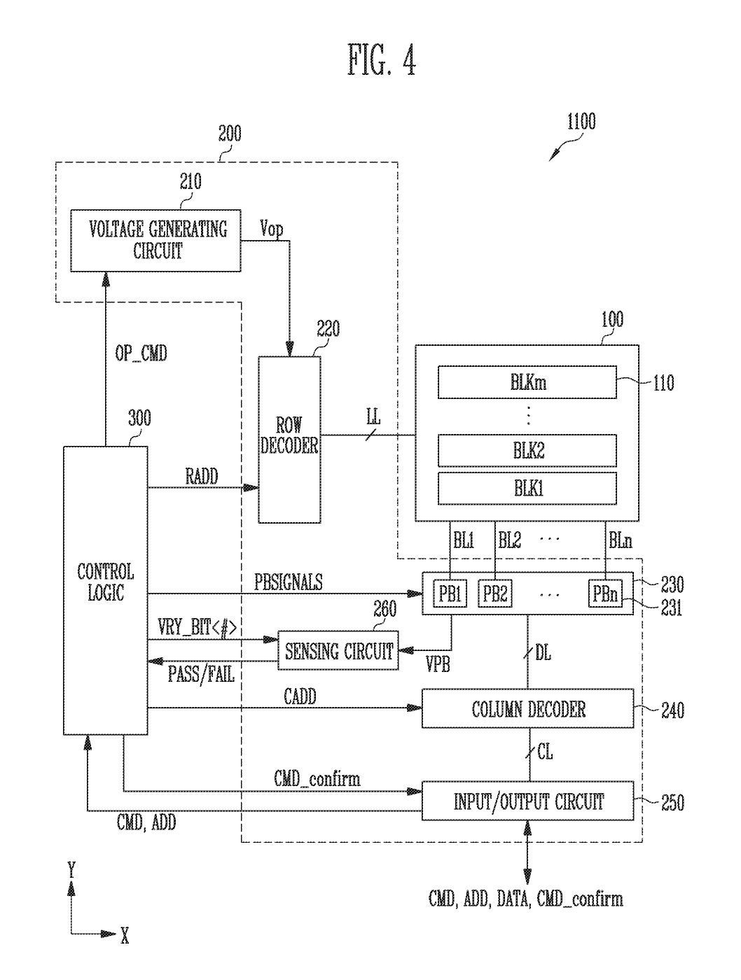

FIG. 4 is a diagram illustrating the nonvolatile memory device 1100 of FIG. 1.

Referring to FIG. 4, the nonvolatile memory device 1100 may include a memory cell array 100 for storing data. The nonvolatile memory device 1100 may include a peripheral circuit 200 configured to perform a write operation for storing data in the memory cell array 100, a read operation for outputting the stored data, and an erase operation for erasing the stored data. The nonvolatile memory device 1100 may include a control logic 300 for controlling the peripheral circuit 200 under the control of the memory controller 1200 of FIG. 1.

The memory cell array 100 may include a plurality of memory blocks BLK1 to BLKm (m is a positive integer) 110. Local lines LL and bit lines BL1 to BLn (n is a positive integer) may be coupled to the memory blocks BLK1 to BLKm 110. For example, the local lines LL may include a first select line, a second select line, and a plurality of word lines arranged between the first and second select lines. Also, the local lines LL may further include dummy lines arranged between the first select line and the word lines and between the second select line and the word lines. The first select line may be a source select line, and the second select line may be a drain select line. For example, the local lines LL may include word lines, drain and source select lines, and source lines SL. For example, the local lines LL may further include dummy lines. For example, the local lines LL may further include pipe lines. The local lines LL may be coupled to the memory blocks BLK1 to BLKm 110, respectively, and the bit lines BL1 to BLn may be commonly coupled to the memory blocks BLK1 to BLKm 110. The memory blocks BLK1 to BLKm 110 may be implemented in a two-dimensional or three-dimensional structure. For example, memory cells may be arranged in a direction parallel to a substrate in memory blocks 110 having a two-dimensional structure. For example, memory cells may be arranged in a direction vertical to a substrate in memory blocks 110 having a three-dimensional structure.

The peripheral circuit 200 may be configured to perform write, read, and erase operations of a selected memory block 110 under the control of the control logic 300. For example, the peripheral circuit 200, under the control of the control logic 300, may supply verify and pass voltages to the first select line, the second select line, and the word lines, selectively discharge the first select line, the second select line, and the word lines, and verify memory cells coupled a selected word line among the word lines. For example, the peripheral circuit 200 may include a voltage generating circuit 210, a row decoder 220, a page buffer group 230, a column decoder 240, an input/output circuit 250, and a sensing circuit 260.

The voltage generating circuit 210 may generate various operating voltages Vop used for program, read, and erase operations in response to an operation signal OP_CMD. Also, the voltage generating circuit 210 may selectively discharge the local lines LL in response to the operation signal OP_CMD. For example, the voltage generating circuit 210 may generate a program voltage, a verify voltage, pass voltages, a turn-on voltage, a read voltage, an erase voltage, a source line voltage, and the like under the control of the control logic 300.

The row decoder 220 may transfer the operating voltages Vop to local lines LL coupled to a selected memory block 110 in response to a row address RADD.

The page buffer group 230 may include a plurality of page buffers PB1 to PBn 231 coupled to the bit lines BL1 to BLn. The page buffers PB1 to PBn 231 may operate in response to page buffer control signals PBSIGNALS. For example, the page buffers PB1 to PBn 231 receive write data DATA received from the outside in a write operation through the input/output circuit 250 and the column decoder 240 to be temporarily stored therein, and adjust potential levels of the corresponding bit lines BL1 to BLn according to the temporarily stored write data DATA. Also, the page buffers PB1 to PBn 231 may sense voltages or currents of the bit lines BL1 to BLn in a read operation or verify operation.

The column decoder 240 may transfer data between the input/output circuit 250 and the page buffer group 230 in response to a column address CADD. For example, the column decoder 240 may exchange data with the page buffers 231 through data lines DL, or exchange data with the input/output circuit 250 through column lines CL.

The input/output circuit 250 may transfer an internal command CMD and address ADD, which are received from the memory controller 1200 of FIG. 1, to the control logic 300, or exchange data DATA with the column decoder 240.

The sensing circuit 260, in a read operation and a verify operation, may generate a reference current in response to a permission bit VRY_BIT<#>, and output a pass signal PASS or a fail signal FAIL by comparing a sensing voltage VPB received from the page buffer group 230 with a reference voltage generated by the reference current.

The control logic 300 may control the peripheral circuit 200 by outputting the operation signal OP_CMD, the row address RADD, the page buffer control signals PBSIGNALS, and the permission bit VRY_BIT<#>in response to the internal command CMD and the address ADD. Also, the control logic 300 may determine whether the verify operation has passed or failed in response to the pass or fail signal PASS or FAIL.

In an operation of the non-volatile memory device 1100, each memory block 110 may be a unit of an erase operation. In other words, a plurality of memory cells included in the memory blocks 110 are simultaneously erased, and may not be selectively erased.

The control logic 300 may output an operation completion signal CMD_confirm when the control logic 300 normally receives a command CMD from the outside and completes an operation, e.g., a write, read or erase operation corresponding to the command CMD is completed. The operation completion signal CMD_confirm output from the control logic 300 may be output to the memory controller 1200 of FIG. 1 through the input/output circuit 250.

When an error occurs in a write operation, the nonvolatile memory device 1100 may re-perform the write operation by newly receiving write data DATA from the buffer memory device 1300 of FIG. 1 or the memory buffer 320 of FIG. 1. The write operation may be performed by selecting a new memory block (any one of BLK1 to BLKm).

Also, when an error occurs in a write operation during the performance of a flush operation since a flush command is received from the host 2000 of FIG. 1, the nonvolatile memory device 1100 may output write data DATA temporarily stored in the page buffer group 230 to the memory controller 1200 of FIG. 1, and re-perform the write operation by newly receiving write data DATA of which error is corrected by the memory controller 1200. The write operation may be performed by selecting a new memory block (any one of BLK1 to BLKm).

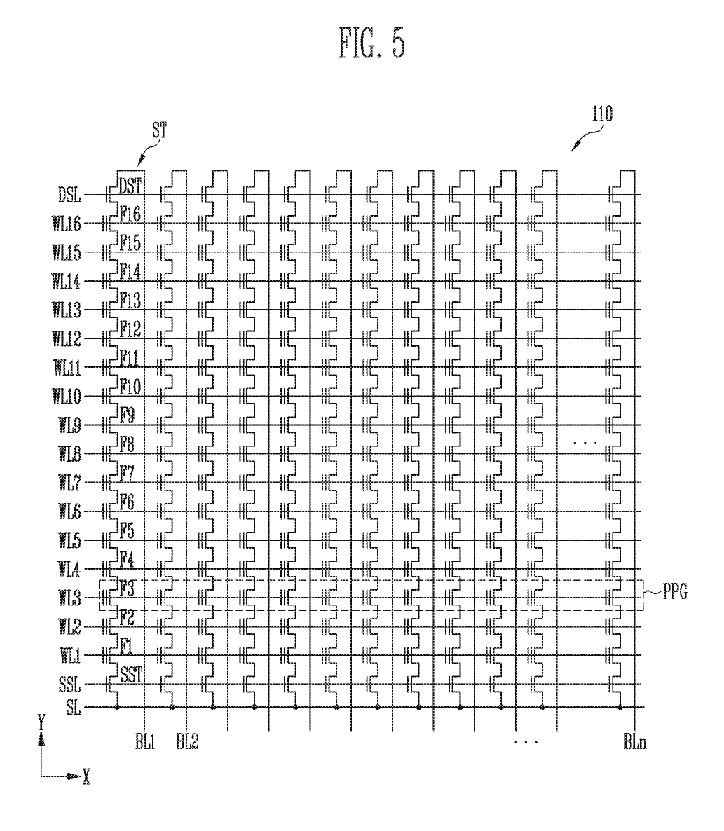

FIG. 5 is a diagram illustrating any one memory block among the plurality of memory blocks BLK1 to BLKm 110 of FIG. 4.

Referring to FIG. 5, a plurality of word lines arranged in parallel to one another between a first select line and a second select line may be coupled to the first memory block 110. The first select line may be a source select line SSL, and the second select line may be a drain select line DSL. More specifically, the first memory block 110 may include a plurality of strings ST coupled between bit lines BL1 to BLn and a source line SL. The bit lines BL1 to BLn may be coupled to the strings ST, respectively, and the source line SL may be commonly coupled to the strings ST. The strings ST may be configured identically to one another, and therefore, a string ST coupled to a first bit line BL1 will be described in detail as an example.

The string ST may include a source select transistor SST, a plurality of memory cells F1 to F16, and a drain select transistor DST, which are coupled in series to each other between the source line SL and the first bit line BL1. At least one source select transistor SST and at least one drain select transistor DST may be included in one string ST, and memory cells of which number is larger than that of the memory cells F1 to F16 shown in the drawing may be included in one string ST.

A source of the source select transistor SST may be coupled to the source line SL, and a drain of the drain select transistor DST may be coupled to the first bit line BL1. The memory cells F1 to F16 may be coupled in series between the source select transistor SST and the drain select transistor DST. Gates of source select transistors SST included in different strings ST may be coupled to the source select line SSL, gates of drain select transistors DST included in different strings ST may be coupled to the drain select line DSL, gates of the memory cells F1 to F16 included in different strings ST may be coupled to a plurality of word lines WL1 to WL16. A group of memory cells coupled to the same word line among the memory cells included in different strings ST may be a physical page PPG. Therefore, physical pages PPGs of which number corresponds to that of the word lines WL1 to WL16 may be included in the first memory block 110.

One memory cell MC may store data of one bit. This is generally called as a single level cell (SLC). One physical page PPG may store one logical page (LPG) data. The one LPG data may include data bits of which number corresponds to that of cells included in one physical page PPG. In addition, one memory cell MC may store data of two or more bits. This is generally called as a multi-level cell (MLC). One physical page PPG may store two or more LPG data.

When the memory cell stores data of two bits, one physical page PPG may include two pages PG. One page PG may store one LPG data. One memory cell may have any one of a plurality of threshold voltages according to data, and a plurality of pages PG included in one physical page PPG may be expressed using a difference in threshold voltage.

A plurality of memory cells included in one physical page PPG may be simultaneously programmed. In other words, the nonvolatile memory device 1100 may perform a program operation in units of physical pages PPG. A plurality of memory cells included in one memory block may be simultaneously erased. In other words, the nonvolatile memory device 1100 may perform an erase operation in units of memory blocks 110. In an example, in order to update a portion of data stored in one memory block 110, after data required to be updated among the entire data is modified by reading the entire data stored in the memory block 110, the entire data may be again programmed in another memory block 110.

FIG. 6 is a flowchart describing an operating method of the memory system 1000 according to an embodiment of the present disclosure.

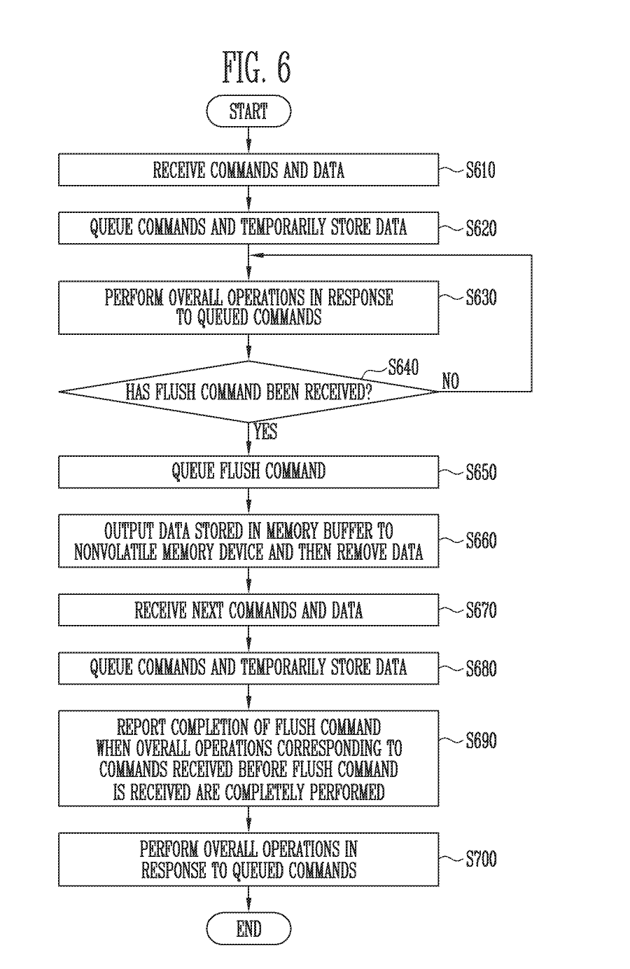

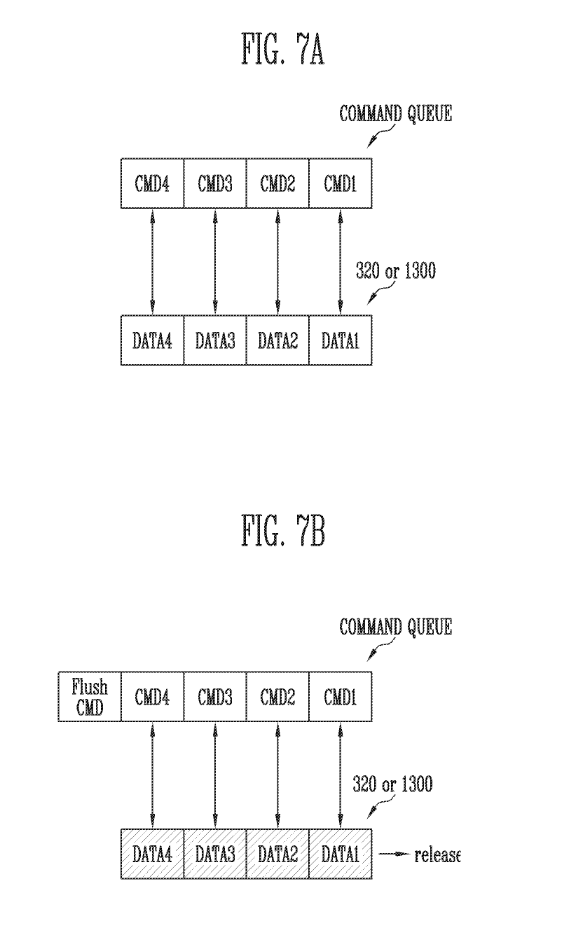

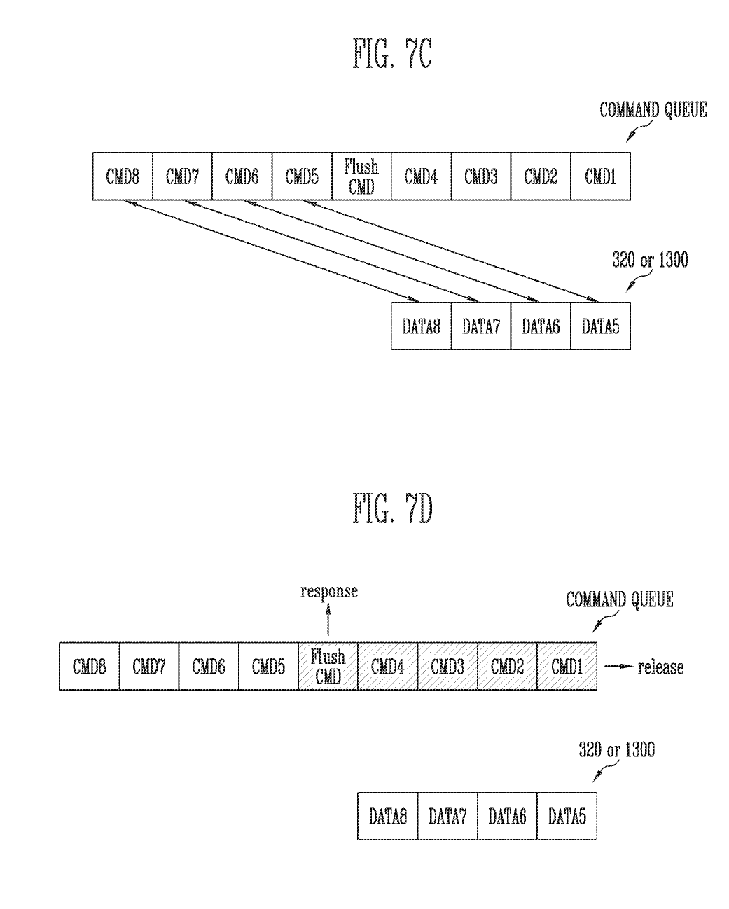

FIGS. 7A to 7D are diagrams of a command queue and the memory buffer 320 or the buffer memory device 1300, illustrating the operating method of the memory system 1000 according to the embodiment of the present disclosure.

In the embodiment of the present disclosure, for convenience of illustration, a case where a plurality of write commands and a flush command are consecutively received from the host 2000, and write commands are subsequently received after the flush command is received will be described as an example.

Commands and data corresponding to the commands are input from the host 2000 to the memory controller 1200 at step 5610.

The processor 310 of the memory controller 1200 determines whether the received commands are commands corresponding to write operations, read operations or erase operation, or commands corresponding to the flush command. When the received commands are commands corresponding to write operations, read operations or erase operations, the processor 310 queues the received commands in a command queue, based on their orders of priority, and temporarily stores the data received from the host 2000 in the controller buffer memory (i.e., the buffer memory device 1300 of FIG. 1 or the memory buffer 320 of FIG. 2) by controlling the buffer memory interface 340 or the buffer control circuit 360 at step 5620. Referring to FIG. 7A, a plurality of commands CMD1 to CMD4 received from the host 2000 are queued in the command queue based on their orders of priority. It is assumed that the plurality of commands CMD1 to CMD4 are write commands. In addition, write data DATA1 to DATA4 respectively corresponding to the plurality of commands CMD1 to CMD4 are temporarily stored in the controller buffer memory (i.e., the buffer memory device 1300 of FIG. 1 or the memory buffer 320 of FIG. 2).

The processor 310 sequentially transmits the plurality of queued commands to the nonvolatile memory device 1100 and controls the nonvolatile memory device 1100 to perform overall operations (e.g., write operations) in response to the received commands at step S630. For example, the flash controller 312 of the processor 310 may transmit a write command to the nonvolatile memory device 1100, and control a write operation of the nonvolatile memory device 1100 by transmitting write data corresponding to the transmitted write command from the memory buffer 320 or the buffer memory device 1300 to the nonvolatile memory device 1100. The write data transmitted to the nonvolatile memory device 1100 is temporarily kept stored in the memory buffer 320 or the buffer memory device 1300. When an error occurs in the write operation of the nonvolatile memory device 1100, the flash controller 312 of the processor 310 may control the nonvolatile memory device 1100 to re-perform the write operation by re-transmitting the temporarily stored write data to the nonvolatile memory device 1100.

A new command may be received from the host 2000 during the overall operations of the nonvolatile memory device 1100. The processor 310 of the memory controller 1200 determines whether the received command is a flush command at step S640.

In the step S640, when it is determined that the new command is not the flash command (“NO” at step S640), the performing of the overall operation in the step S630 is maintained.

In the step S640, when it is determined that the new command is the flash command (“YES” at step S640), the processor 310 controls the memory system 1000 to perform a flush operation. The processor 310 queues the flush command in the command queue at step S650. The flush command is queued at the tail of the command queue, which means that the flush command has lower priority than the commands queued before the flush command is received.

The flash controller 312 may transmit the write data buffered to the memory buffer 320 or the buffer memory device 1300 to the nonvolatile memory device 1100, and release all write data temporarily stored in the memory buffer 320 or the buffer memory device 1300 at step S660.

Referring to FIG. 7B, a flush command Flush CMD is queued in the command queue to have an order next to those of the commands CMD1 to CMD4 received earlier than the flush command Flush CMD. In addition, write data DATA1 to DATA4 corresponding to the commands CMD1 to CMD4 received earlier than the flush command Flush CMD are transmitted to the nonvolatile memory device 1100. The write data (data DATA1 to DATA4 in an area indicated by a deviant crease line in FIG. 7B), which have been completely transmitted to the nonvolatile memory device 1100, are released from the memory buffer 320 or the buffer memory device 1300.

When an error occurs in a write operation while a flush operation is being performed since a flush command is received from the host 2000, the nonvolatile memory device 1100 may output write data DATA temporarily stored in the page buffer group 230 to the memory controller 1200 and re-perform the write operation by newly receiving the write data DATA, error of which is corrected by the memory controller 1200. The write operation may be performed by selecting a new memory block (i.e., any one of BLK1 to BLKm of FIG. 4).

During the flush operation, next commands and data corresponding to the next commands may be received from the host 2000 to the memory controller 1200 at step S670.

The processor 310 queues the next commands in the command queue, and temporarily stores the next data received from the host 2000 in the controller buffer memory (i.e., the buffer memory device 1300 or the memory buffer 320) by controlling the buffer memory interface 340 or the buffer control circuit 360 at step S680. Referring to FIG. 7C, a plurality of commands CMD5 to CMD8 newly received from the host are queued based on their orders of priority to constitute the command queue. The plurality of commands CMD5 to CMD8 newly received after the flush command Flush CMD is received are preferably queued to have an order next to that of the flush command Flush CMD. When assuming that the plurality of commands CMD5 to CMD8 are write commands, write data DATA5 to DATA8 respectively corresponding to the plurality of commands CMD5 to CMD8 are temporarily stored in the controller buffer memory (Le., the buffer memory device 1300 or the memory buffer 320).

When overall operations (e.g., write operations) corresponding to the commands received from the processor 310 are completed, the nonvolatile memory device 1100 may output an operation completion signal CMD_confirm. When overall operations corresponding to the commands CMD1 to DMD4 received before the flush command Flush CMD is received are completely performed, which is reported to the processor 310 through the operation completion signal CMD_confirm received from the nonvolatile memory device 1100, the processor 310 may generate a response signal in response to the flush command Flush CMD and output the response signal to the host 2000 at step S690. When the response signal is output, the flush operation may end.

Referring to FIG. 7D, the processor 310 determines based on the operation completion signal CMD_confirm received from the memory device 1100 whether the overall operations have been completely performed in response to the commands CMD1 to CMD4 received before the flush command Flush CMD is received. When it is determined that the overall operations have been completely performed in response to the commands CMD1 to DMD4, the processor 310 generates a response signal corresponding to the flush command Flush CMD and outputs the response signal to the host 2000. After this, the flush command Flush CMD and the commands CMD1 to CMD4 received before the flush command Flush CMD is received may be dequeued from the command queue. That is, the commands Flush CMD and CMD1 to CMD4 included in an area indicated by a deviant crease line as shown in FIG. 7D may be released.

After the flush operation ends, the processor 310 sequentially transmits the queued commands to the nonvolatile memory device 1100 after the flush command, and controls the nonvolatile memory device 1100 to perform the overall operations (e.g., write operations) in response to the received commands at step S700.

As described above, according to the embodiment of the present disclosure, in a flush operation, the flash controller 312 transmits write data buffered in the controller buffer memory (Le., the memory buffer 320 or the buffer memory device 1300) to the nonvolatile memory device 1100 and then releases all write data temporarily stored in the controller buffer memory. Accordingly, an empty storage space of the controller buffer memory can be secured, write data received from the host 2000 after a flush command is received can be stored in the controller buffer memory, and a write operation can be performed by transmitting the write data stored in the controller buffer memory to the nonvolatile memory device 1100 after the flush operation is completely performed. Thus, the time required to buffer write data to the controller buffer memory after the flush operation can be reduced, and the amount of write data stored in the controller buffer memory can satisfy the write performance of the memory system, thereby improving the write performance.

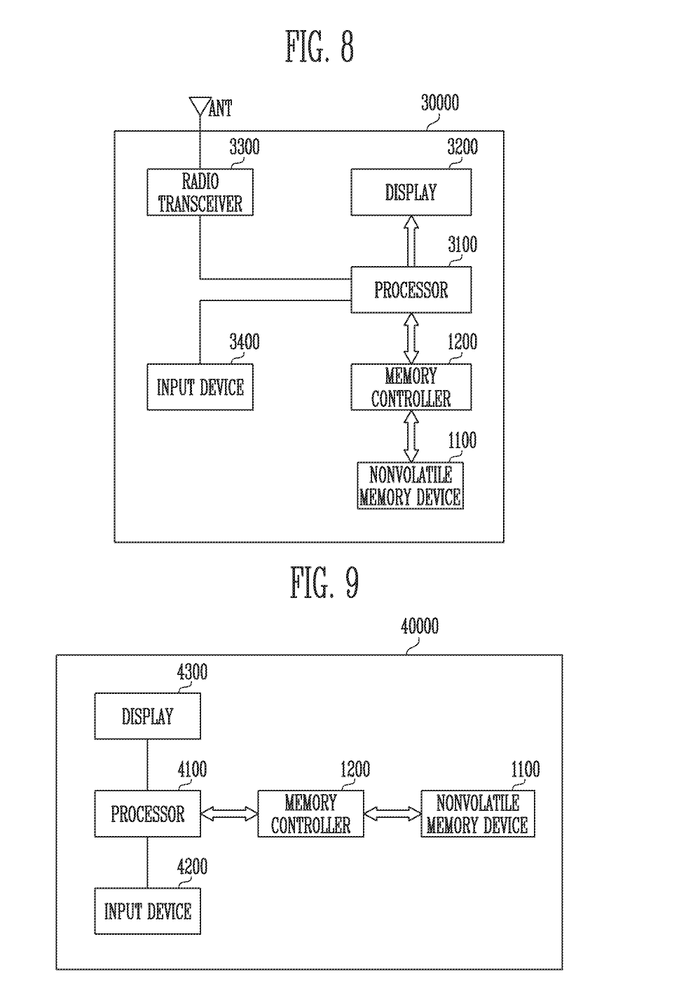

FIG. 8 is a diagram illustrating an embodiment of the memory system.

Referring to FIG. 8, the memory system 30000 may be implemented as a cellular phone, a smart phone, a tablet PC, a personal digital assistant (PDA), or a wireless communication device. The memory system 30000 may include a nonvolatile memory device 1100 and a memory controller 1200 capable of controlling an operation of the nonvolatile memory device 1100. The memory controller 1200 may control a data access operation of the nonvolatile memory device 1100, e.g., a program operation, an erase operation, or a read operation under the control of a processor 3100.

Data programmed in the nonvolatile memory device 1100 may be output through a display 3200 under the control of the memory controller 1200.

A radio transceiver 3300 may transmit/receive radio signals through an antenna ANT. For example, the radio transceiver 3300 may convert a radio signal received through the antenna ANT into a signal that can be processed by the processor 3100. Therefore, the processor 3100 may process a signal output from the radio transceiver 3300 and transmit the processed signal to the memory controller 1200 or the display 3200. The memory controller 1200 may program the signal processed by the processor 3100 in the nonvolatile memory device 1100. Also, the radio transceiver 3300 may convert a signal output from the processor 3100 into a radio signal, and output the converted radio signal to an external device through the antenna ANT. An input device 3400 is a device capable of inputting a control signal for controlling an operation of the processor 3100 or data to be processed by the processor 3100, and may be implemented as a pointing device such as a touch pad or a computer mount, a keypad, or a keyboard. The processor 3100 may control an operation of the display 3200 such that data output from the memory controller 1200, data output from the radio transceiver 3300, or data output from the input device 3400 can be output through the display 3200.

In some embodiments, the memory controller 1200 capable of controlling an operation of the nonvolatile memory device 1100 may be implemented as a part of the processor 3100, or be implemented as a chip separate from the processor 3100. Also, the memory controller 1200 may be implemented with the memory controller shown in FIG. 2.

FIG. 9 is a diagram illustrating an embodiment of the memory system.

Referring to FIG. 9, the memory system 40000 may be implemented as a personal computer (PC), a tablet PC, a net-book, an e-reader, a personal digital assistant (PDA), a portable multimedia player (PMP), an MP3 player, or an MP4 player.

The memory system 40000 may include a nonvolatile memory device 1100 and a memory controller 1200 capable of controlling a data processing operation of the nonvolatile memory device 1100.

The processor 4100 may output data stored in the nonvolatile memory device 1100 through a display 4300 according to data input through an input device 4200. For example, the input device 4200 may be implemented as a pointing device such as a touch pad or a computer mouse, a keypad, or a keyboard.

The processor 4100 may control the overall operations of the memory system 40000, and control an operation of the memory controller 1200. In some embodiments, the memory controller 1200 capable of controlling an operation of the nonvolatile memory device 1100 may be implemented as a part of the processor 4100, or be implemented as a chip separate from the processor 4100. Also, the memory controller 1200 may be implemented with the memory controller shown in FIG. 2.

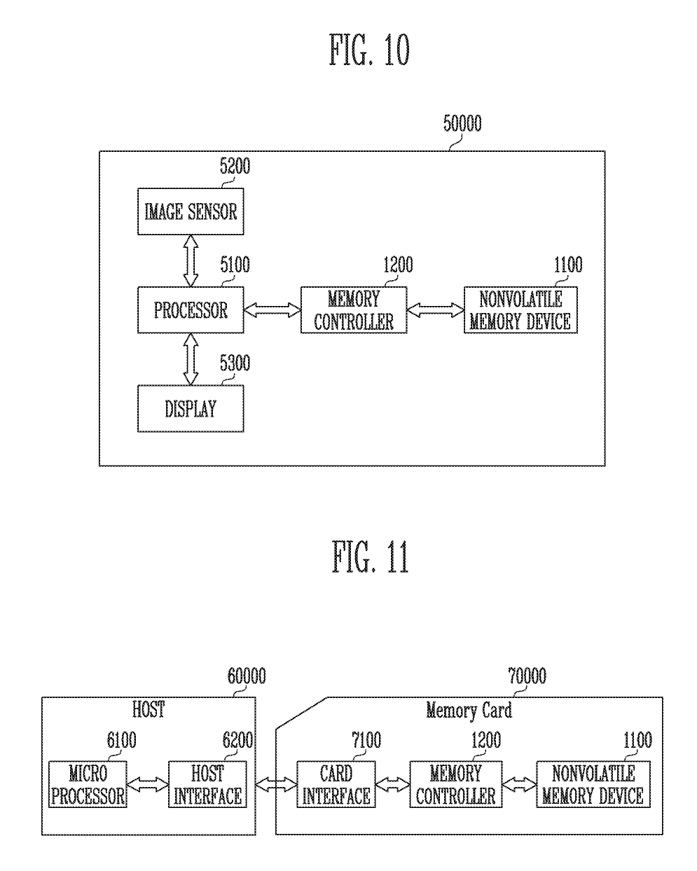

FIG. 10 is a diagram illustrating an embodiment of the memory system.

Referring to FIG. 10, the memory system 50000 may be implemented as an image processing device, e.g., a digital camera, a mobile terminal having a digital camera attached thereto, a smart phone having a digital camera attached thereto, or a tablet PC having a digital camera attached thereto.

The memory system 50000 may include a nonvolatile memory device 1100 and a memory controller 1200 capable of controlling a data processing operation of the nonvolatile memory device 1100, e.g., a program operation, an erase operation, or a read operation.

An image sensor 5200 of the memory system 50000 may convert an optical image into digital signals, and the converted digital signals may be transmitted to the processor 5100 or the memory controller 1200. Under the control of the processor 5100, the converted digital signals may be output through a display 5300, or be stored in the nonvolatile memory device 1100 through the memory controller 1200. In addition, data stored in the nonvolatile memory device 1100 may be output through the display 5300 under the control of the processor 5100 or the memory controller 1200.

In some embodiments, the nonvolatile memory controller 1200 capable of controlling an operation of the nonvolatile memory device 1100 may be implemented as a part of the processor 5100, or be implemented as a chip separate from the processor 5100. Also, the memory controller 1200 may be implemented with the memory controller shown in FIG. 2.

FIG. 11 is a diagram illustrating an embodiment of the memory system.

Referring to FIG. 11, the memory system 70000 may be implemented as a memory card or a smart card. The memory system 70000 may include a nonvolatile memory device 1100, a memory controller 1200, and a card interface 7100.

The memory controller 1200 may control data exchange between the nonvolatile memory device 1100 and the card interface 7100. In some embodiments, the card interface 7100 may be a secure digital (SD) card interface or a multi-media card (MMC) interface, but the present disclosure is not limited thereto. Also, the memory controller 1200 may be implemented with the memory controller shown in FIG. 2.

The card interface 7100 may interface data exchange between a host 60000 and the memory controller 1200 according to a protocol of the host 60000. In some embodiments, the card interface 7100 may support a universal serial bus (USB) protocol and an inter-chip (IC)-USB protocol. The card interface 7100 may mean hardware capable of supporting a protocol used by the host 60000, software embedded in the hardware, or a signal transmission scheme.

When the memory system 70000 is coupled to a host interface 6200 of the host 60000 such as a PC, a tablet PC, a digital camera, a digital audio player, a cellular phone, console video game hardware, or a digital set-top box, the host interface 6200 may perform data communication with the nonvolatile memory device 1100 through the card interface 7100 and the memory controller 1200 under the control of a microprocessor 6100.

According to the present disclosure, although a flush command is input in an operation of the memory system, the memory system operates without blocking commands input next to the flush command. Thus, the memory system can continuously operate, and accordingly, the operating speed of the memory system can be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A memory system comprising:
a memory controller configured to queue commands received from a host, and sequentially output the queued commands;
a controller buffer memory configured to temporarily store write data corresponding to the commands, and output the temporarily stored write data under the control of the memory controller; and
a nonvolatile memory device configured to perform operations in response to the commands output from the memory controller and the write data output from the controller buffer memory, and output an operation completion signal to the memory controller when the operations are completed,
wherein, when a flush command is received from the host, the memory controller releases the write data temporarily stored in the controller buffer memory.

2. The memory system of claim 1, wherein the memory controller controls the controller buffer memory such that write data received from the host after the flush command is received are buffered to the released controller buffer memory.

3. The memory system of claim 1, wherein the controller buffer memory temporarily stores the temporarily stored write data even after the temporarily stored write data are output to the nonvolatile memory device.

4. The memory system of claim 3, wherein, when a write error occurs during the operations of the nonvolatile memory device before the flush command is received, the memory controller controls the nonvolatile memory device and the controller buffer memory to re-perform the operations by re-transmitting the write data temporarily stored in the controller buffer memory to the nonvolatile memory device.

5. The memory system of claim 3, wherein, when the flush command is received, the controller buffer memory releases the temporarily stored write data from the controller buffer memory.

6. The memory system of claim 5, wherein, when a write error occurs during the operations of the nonvolatile memory device after the flush command is received, the memory controller controls the nonvolatile memory device to re-perform the operations by error-correcting the write data stored in a page buffer group of the nonvolatile memory device, and then transmitting the error-corrected write data to the nonvolatile memory device.

7. The memory system of claim 1, wherein, when the flush command is received, the memory controller queues the flush command next to the commands.

8. The memory system of claim 1, wherein, when the flush command is received, the memory controller outputs a response signal corresponding to the flush command to the host when the nonvolatile memory device is determined on the basis of the operation completion signal to complete the operations in response to the commands.

9. The memory system of claim 8,
wherein the memory controller includes a processor configured to queue the commands received from the host based on their orders of priority, and sequentially transmit the queued commands to the nonvolatile memory device,
wherein the processor subsequently queues new commands received after the flush command is received, and temporarily stores new write data corresponding to the new commands in the controller buffer memory from which the write data are released.

10. The memory system of claim 9, wherein, after the response signal corresponding to the flush command is output to the host, the processor controls the nonvolatile memory device to perform new operations by transmitting the subsequently queued commands and the new write data temporarily stored in the controller buffer memory.

11. A memory system comprising:
a memory controller configured to receive commands and write data corresponding to the commands from a host, queue the received commands, and output the queued commands and the write data; and
a nonvolatile memory device configured to perform operations in response to the commands and the write data, which are output from the memory controller, and outputs an operation completion signal to the memory controller when the operations are completed,
wherein, when a flush command is received, the memory controller releases the write data temporarily stored after the write data are transmitted to the nonvolatile memory device.

12. The memory system of claim 11, wherein the memory controller includes:
a processor configured to queue the commands received from the host based on their orders of priority; and
a memory buffer configured to temporarily store the write data.

13. The memory system of claim 12, wherein, when the flush command is received, the processor queues the flush command next to the commands, and releases the write data stored in the memory buffer.

14. The memory system of claim 13, wherein, when new commands are received from the host after the flush command is received, the processor queues the new commands next to the flush command, and temporarily stores new data corresponding to the new commands in the memory buffer from which the write data are released.

15. The memory system of claim 12, wherein, when a write error occurs during the operations of the nonvolatile memory device before the flush command is received, the processor controls the nonvolatile memory device and the memory buffer to re-perform the operations by re-transmitting the write data stored in the memory buffer to the nonvolatile memory device.

16. The memory system of claim 12, wherein, when a write error occurs during the operations of the nonvolatile memory device after the flush command is received, the processor controls the nonvolatile memory device to re-perform the operations by error-correcting the write data stored in a page buffer group of the nonvolatile memory device, and then transmitting the error-corrected write data to the nonvolatile memory device.

17. The memory system of claim 14, wherein, when the flush command is received, the memory controller outputs a response signal corresponding to the flush command to the host when the nonvolatile memory device is determined on the basis of the operation completion signal to complete the operations in response to the commands.

18. The memory system of claim 17, wherein, after the response signal corresponding to the flush command is output to the host, the processor controls the nonvolatile memory device to perform new operations by transmitting subsequently queued commands and new write data temporarily stored in the memory buffer.

19. A method for operating a memory system, the method comprising:
queuing commands received from a host, and temporarily storing write data corresponding to the commands in a controller buffer memory;
performing operations by transmitting the queued commands and the write data stored in the controller buffer memory to a nonvolatile memory device;
when a flush command is received from the host, queuing the flush command next to the queued commands and releasing the write data temporarily stored in the controller buffer memory; and
queuing, next to the flush command, new commands received from the host after the flush command is received, and temporarily storing new write data corresponding to the new commands in the controller buffer memory from which the write data are released.

20. The method of claim 19, further comprising re-performing, when a write error occurs during the operations before the flush command is received, the operations by re-transmitting the write data temporarily stored in the controller buffer memory to the nonvolatile memory device.

21. The method of claim 19, further comprising re-performing, when a write error occurs during the operations after the flush command is received, the operations by error-correcting the write data stored in a page buffer group of the nonvolatile memory device, and then transmitting the error-corrected write data to the nonvolatile memory device.

22. The method of claim 19, further comprising outputting, after the flush command is received, a response signal corresponding to the flush command to the host when the operations corresponding to the commands received before the flush command is received are completed by the nonvolatile memory device.

23. The method of claim 22, further comprising, after the response signal corresponding to the flush command is output to the host, performing new operations by transmitting, to the nonvolatile memory device, the newly queued commands and the new write data temporarily stored in the controller buffer memory.
